(19) United States
(12) Patent Application Publication
(10) Pub. No.: US 2012/0200622 A1
(43) Pub. Date: Aug. 9, 2012

(54) INKJET RECORDING DEVICE

(76) Inventors: Tomohiro Inoue, Tsukuba (JP); Akira Miyao, Hitachi (JP); Toshihide Nagamine, Tokai (JP)

(21) Appl. No.: 13/380,717

(22) PCT Filed: Feb. 23, 2010
(86) PCT No.: PCT/JP2010/001164

§ 371 Date: Apr. 23, 2012

(30) Foreign Application Priority Data
Jun. 25, 2009 (JP) 2009-150681

(51) Int. Cl. B41J 2/185; B41J 2/19; B41J 29/38

(52) U.S. Cl. 347/6; 347/90

(57) ABSTRACT

Leakage of an ink remaining in a gutter or the like is prevented. An inkjet recording device includes an ink tank for retaining an ink, a nozzle for discharging the ink as ink particles to print on a printing object, an ink supply unit for feeding the ink from the ink tank to the nozzle, a gutter for recovering the ink particles which are not used in printing in the ink tank among the ink particles discharged from the nozzle, an ink recovery line for returning the ink particles recovered in this gutter to the ink tank, and an ink recovery unit disposed on this ink recovery line for recovering the ink in the ink tank. The inkjet recording device has a gas-liquid separation unit for separating a gas returned along with the ink particles through the ink recovery line, a gas supply line for feeding the gas to the gutter, and an atmosphere relief line for releasing the gas from the gas-liquid separation unit to the outside.

### RELATED APPLICATIONS

This application is the U.S. National Phase under 35 U.S.C. §371 of International Application No. PCT/JP2010/001164, filed on Feb. 23, 2010, which in turn claims the benefit of Japanese Application No. 2009-150681, filed on Jun. 25, 2009, the disclosures of which Applications are incorporated by reference herein.

### TECHNICAL FIELD

The present invention relates to an inkjet recording device.

### BACKGROUND ART

In an inkjet recording device which prints out by ejecting an ink from a nozzle, it is necessary to supply a solvent for volatilized and lost ink to maintain the properties of the ink when the ink discharged from the nozzle once is recovered and reused.

Patent document 1(Japanese Unexamined Patent Publication No. 60-011364) discloses an inkjet recording device for the purpose of providing an ink circulation system with less ink deterioration which suppresses vaporization of ink solvent components, the inkjet recording device being characterized in that in the ink circulation system in a continuous ink jet printer, the ink circulation system being constituted by an ink supply system which feeds an ink from an ink tank to a nozzle under pressure, a gutter which recovers ink particles which is not used for printing of the ink ejected from the nozzle; and an ink recovery system which sucks and recovers the ink to the gutter into an ink tank, air containing the solvent components of the ink which is sucked and recovered from the gutter along with the ink is circulated to the gutter.

Patent document 2 (Japanese Unexamined Utility Model Publication No. 60-152436) discloses a gutter in a continuous inkjet recording device which recovers the ink particles which are not used in printing in a group of ink particles ejected from a nozzle characterized in that the inner wall of the gutter is made washable with a cleaning liquid during printing.

Patent document 3(Japanese Unexamined Patent Publication No. 2008-279598) discloses an inkjet recording device which performs printing with ink particles which are ejected from a nozzle, electrified and deflected, the inkjet recording device having a print head; and a main body, the print head having the nozzle and a gutter which recovers ink particles which are not used in printing, the main body having an ink tank and a supply pump which feeds the ink from this ink tank, the ink tank being connected to a line for feeding the ink to the print head and to a line where the ink recovered from the gutter flows to retain the ink recovered from the gutter, wherein an ejector connected to the gutter and to the ink tank is provided within the print head.

### SUMMARY OF THE INVENTION

In patent document 1, an internal pressure of an air circulation pipe (a solvent gas supply line) which circulates air (a solvent gas) containing the solvent components of the ink to the gutter lowers gradually to the atmospheric pressure due to the fluid resistance of the air circulation pipe when an ink recovery pump is stopped because of the stopping of the inkjet recording device. Accordingly, after the recovery of the ink is stopped, feeding of the solvent gas to the gutter is continued, and the ink remaining in the gutter is pushed out from the gutter by the solvent gas, which then fouls the surrounding of the gutter with the ink. This problem has been left to be solved.

The present invention provides an inkjet recording device which prevents leakage of the ink left in the gutter or other portions.

In order to solve the above-mentioned problem, the inkjet recording device of the present invention includes an ink tank for retaining an ink, a nozzle for discharging the ink as ink particles to print on a printing object, an ink supply unit for feeding the ink from the ink tank to the nozzle, a gutter for recovering the ink particles which are not used in printing in the ink tank among the ink particles discharged from the nozzle, an ink recovery line for returning the ink particles recovered in the gutter to the ink tank, and an ink recovery unit disposed in the ink recovery line for recovering the ink in the ink tank, the inkjet recording device having a gas-liquid separation unit for separating a gas returned along with the ink particles through the ink recovery line, a gas supply line for feeding the gas to the gutter and an atmosphere relief line for releasing the gas from the gas-liquid separation unit to the outside.

A feature of the inkjet recording device of the present invention is that the gas-liquid separation unit is provided in the ink tank.

A feature of the inkjet recording device of the present invention is that the gas supply line and the atmosphere relief line are independent lines.

A feature of the inkjet recording device of the present invention is that a valve is provided on the atmosphere relief line.

A feature of the inkjet recording device of the present invention is that a valve is provided on the gas supply line.

A feature of the inkjet recording device of the present invention is that the valve provided on the atmosphere relief line and/or the gas supply line is a two-way valve.

A feature of the inkjet recording device of the present invention is that a control unit for stopping the recovery of the ink by the ink recovery unit after the valve of the atmosphere relief line is opened is provided.

A feature of the inkjet recording device of the present invention is that a control unit for stopping the recovery of the ink by the ink recovery unit after the valve of the gas supply line is closed is provided.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a schematic constitutional view showing a line system for an ink and a solvent gas in an inkjet recording device of Example 1 according to the present invention.

FIG. 2 is a timing chart showing states of pumps, valves and other components of an inkjet recording device of Example 1 according to the present invention when recovery is stopped.

FIG. 3 is a schematic constitutional view showing a line system of an ink and a solvent gas in an inkjet recording device of Example 2 according to the present invention.

FIG. 4 is a timing chart showing states of pumps, valves and other components of the inkjet recording device of Example 2 according to the present invention when recovery is stopped.

FIG. 5 is a schematic constitutional view showing a control circuit of the inkjet recording device of the present invention.

FIG. 6 is a general perspective view of the inkjet recording device of the present invention.

FIG. 7 is a schematic cross-sectional view of the inkjet recording device of the present invention.

FIG. 8 is a cross-sectional view showing a gutter of the inkjet recording device of the present invention.

FIG. 9 is a schematic constitutional view showing a line system of an ink and a solvent gas in an inkjet recording device of a variant Example according to the present invention.

### DESCRIPTION OF THE PREFERRED EMBODIMENTS

The present invention relates to an inkjet recording device which prints out by ejecting an ink from a nozzle.

Embodiments of the invention will be described below with reference to drawings.

### Example 1

First, FIG. 6 shows a general view of a main body of the inkjet recording device.

The inkjet recording device is composed of a main body 600 which accommodates a control system and a circulation system, a print head 610 which ejects ink particles, and a cable 620 which connects the main body 600 and the print head 610. The length of the cable 620 is 4 m. The main body 600 has a touch panel type liquid crystal panel 630 which enables the user to input a print content, printing specification and other information, and is capable of displaying control details and operational status of the device. A nozzle for producing the ink particles and electrodes for electrifying and deflecting the ink particles are contained within the print head 610. The print head is covered by a cover made of a stainless steel. An opening portion 640 through which the ink particles can pass is provided at the tip of the print head 610. A lid 670 which can be opened and closed in is provided at a lower part of the main body 600, through which an internal maintenance is carried out.

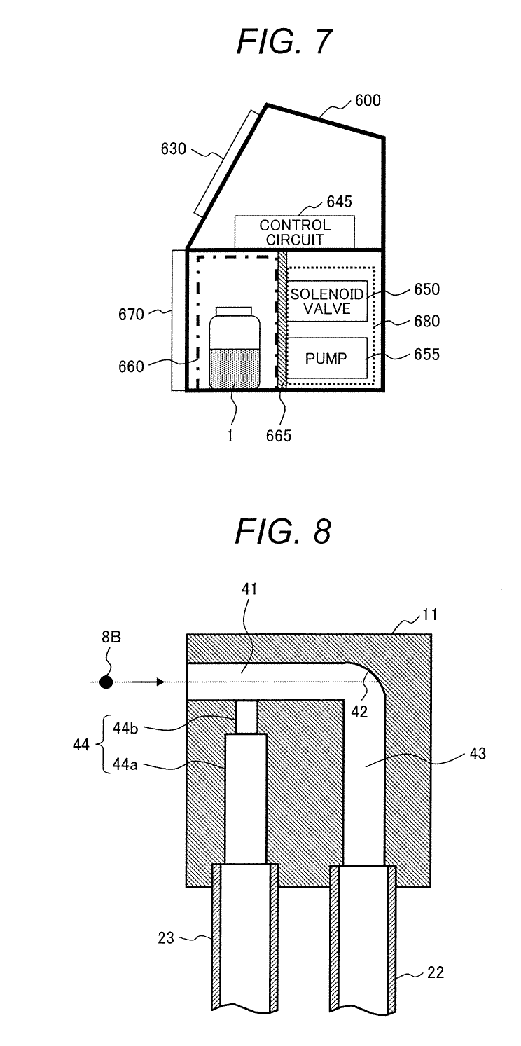

Second, the internal constitution of the main body 600 will be described with reference to FIG. 7.

Electric parts such as a control circuit 645 are disposed in an upper part of the main body 600. Circulation system control parts such as an electromagnetic valve 650 and a pump unit 655 are disposed in a lower body 680, and an ink tank 1 for storing the ink fed to the nozzle is contained in a lower body 660. A lid 670 can be opened and closed so that the ink tank 1 can be withdrawn from the main body 600. Such a constitution facilitates maintenance operations including supply and disposal of the ink and the solvent.

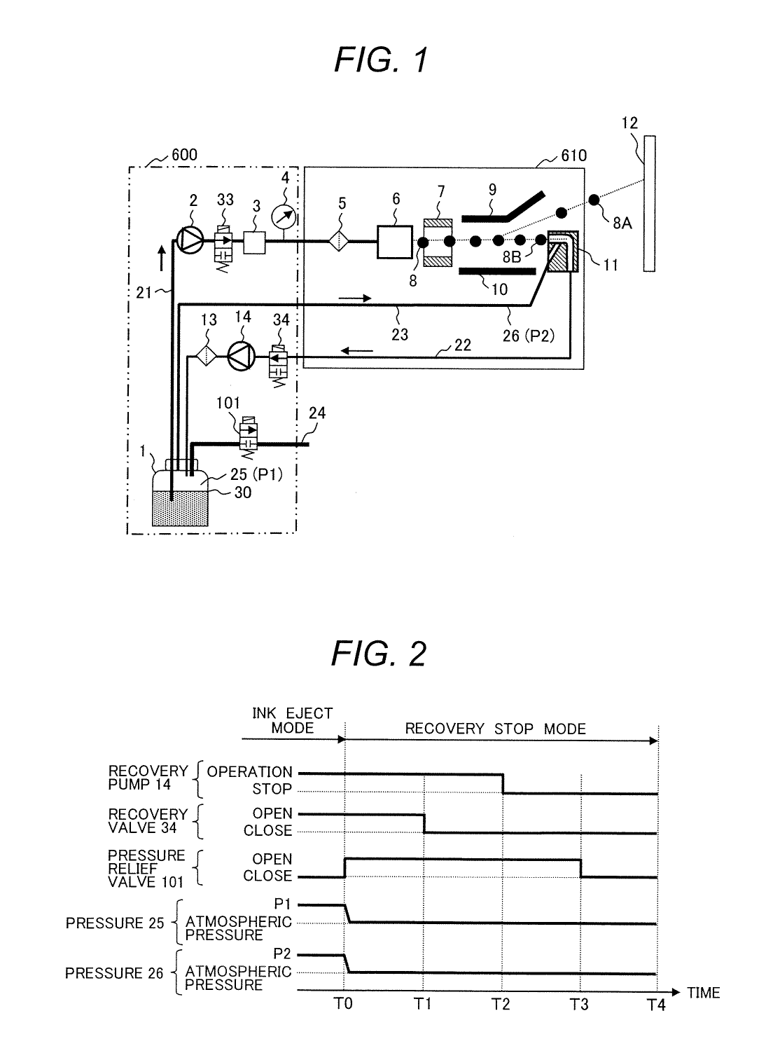

Next, the operation of the inkjet recording device according to the present invention will be described with reference to FIGS. 1 and 8.

FIG. 1 is a schematic constitutional view which shows the line systems of the ink and a solvent gas in the inkjet recording device of Example 1 according to the present invention. FIG. 8 is a cross-sectional view which shows a gutter of the inkjet recording device of the present invention.

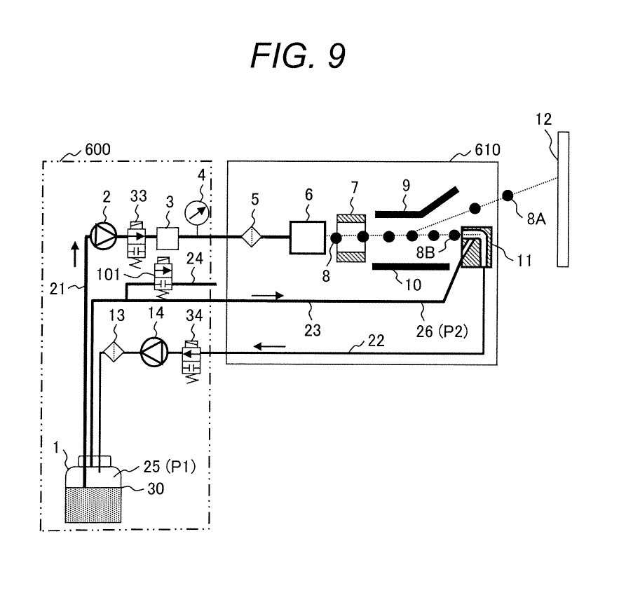

In FIG. 1, the flow of the ink and gas into and out from the ink tank 1 is routed through an ink supply line 21 connected to the ink tank 1, an ink recovery line 22, an exhaust circulation line 23 (also referred to as a gas supply line), and a pressure relief line 24 (also referred to as an atmosphere relief line). In this Example, the exhaust circulation line 23 and the pressure relief line 24 are separately provided. That is, the exhaust circulation line 23 and the pressure relief line 24 configure independent lines, respectively. It should be noted that as shown in the variant Example in FIG. 9, the pressure relief line 24 may be configured to branch from the exhaust circulation line 23.

The ink supply line 21 is configured to include the ink tank 1, a supply pump 2 which force-feeds the ink (also referred to as an ink supply means or an ink supply unit), a supply valve 33 which opens and closes the line, a pressure-adjusting valve 3 which adjusts the pressure of the ink, a pressure gauge 4 which measures the pressure of the fed ink, and a filter 5. The ink supply line 21 feeds the ink in the ink tank 1 to a nozzle 6 at a predetermined pressure.

The ink particles 8 discharged from the nozzle 6 are electrified at a charged electrode 7, and fly between a positive deflection electrode 9 and a negative deflection electrode 10 to which a high voltage of 5 kV is applied. Since an electrostatic field is formed between the positive deflection electrode 9 and negative deflection electrode 10, the electrified ink particles 8A are deflected depending on their amounts of electric charge and deposited on a printing object 12, thereby performing printing. The ink particles 8B which are not used in printing are drawn into a gutter 11 to be recovered.

In FIG. 8, the gutter 11 is composed of a first line 41 for drawing the ink particles 8B which are not used in printing, a second line 43 connected to the ink recovery line 22, a bent line portion 42 which connects the first line 41 and second line 43, and a third line 44 which connects the exhaust circulation line 23 and first line 41. The ink particles 8B which are not used in printing pass through the first line 41, collide against the bent line portion 42, and wet the portion and spreads in the form of a liquid membrane. The spread ink is sucked by a negative pressure generated by the recovery pump 14, and is sucked from the second line 43 to the ink recovery line 22.

Herein, the recovery pump 14 can be also referred to as an ink recovery means or an ink recovery unit.

It should be noted that the recovery pump 14 used in this Example is a diaphragm pump, and is capable of sucking air at a flow rate of 150 ml/min. Therefore, although the ink wets inside the first line 41, the ink can be recovered into the ink tank 1 without leakage from the gutter 11.

The third line 44 feeds the solvent gas flowing from the exhaust circulation line 23 to the first line 41. The third line 44 has a stepped line structure having a restrictor 44b in order to prevent the ink from entering the first line 41. In this Example, a line 44a of the third line 44 has an inner diameter of 1 mm and an inner diameter of the restrictor 44b of 0.3 mm, so that the ink is prevented from entering into the exhaust circulation line 23.

In FIG. 1, the ink recovery line 22 is configured to include a filter 13 which removes foreign substances which have entered the ink recovery line during the recovery of the ink, a recovery pump 14 which generates a negative pressure in the gutter 11, and a recovery valve 34 which opens and closes the ink recovery line, and recovers the ink drawn into the gutter 11 into the ink tank 1. The recovery valve 34 is an electromagnetic two-way valve, which is open during recovery of the ink. It should be noted that the recovery valve 34 is provided on at least the ink recovery line 22, and may be also provided not only in the main body 600 but also in the print head 610. In the gutter 11, the solvent gas fed from the exhaust circulation channel 23 is sucked along with the ink. Therefore, the ink and the gas are recovered in a state of a gas-liquid mixture in the ink recovery line 22, but the ink and the solvent gas are separated in the ink tank 1. That is, the ink tank 1 has a function of separating gases and liquids, and therefore can be also referred to as a gas-liquid separation unit. In other words, the gas-liquid separation unit is provided in the ink tank 1.

It should be noted that the recovery valve 34 may be a flow rate adjustment valve which has a function of adjusting the flow rate.

The ink tank 1 is tightly closed so that the solvent gas does not leak to other portions than the exhaust circulation line 23. Therefore, the solvent gas is led to the exhaust circulation line 23 whose inlet is placed above an ink level 30. Moreover, the ink recovered into the ink tank 1 is sucked out by the supply pump 2 from the ink supply line 21 whose inlet is placed below the ink level 30, and is fed to the nozzle 6. It should be noted that in this Example, an outlet (tube end) of the ink recovery line 22 is placed above the fluid level 30, but may be placed below the same.

The exhaust circulation line 23 is a line which brings the ink tank 1 and the gutter 11 into communication, and feeds the solvent gas separated from the ink recovered in the ink tank 1 to the gutter 11. In this Example, a connecting tube used as the exhaust circulation line 23 is a Teflon (registered trademark) tube having an inner diameter of 2 mm and a length of 4 m, and connects the ink tank 1 and the gutter 11.

Herein, the solvent gas fed to the gutter 11 is fed from the inside of the ink tank 1. Therefore, the vapor pressure of the solvent in the solvent gas has almost reached the saturated vapor pressure. Therefore, evaporation of the solvent from the ink particles 8B recovered in the gutter 11 can be suppressed.

The pressure relief line 24 has a pressure relief valve 101 which opens and closes the line. In this Example, a connecting tube used as the pressure relief line 24 is a Teflon (registered trademark) tube having an inner diameter of 2 mm and a length of 0.5 m, and the tube end on the ink tank 1 side is exposed above the ink level 30, while the tube end on the atmosphere side is exposed on the outside of the main body 600. The pressure relief valve 101 is an electromagnetic two-way valve, and releases the solvent gas to the outside of the main body 600 from the ink tank 1 by opening the same. When the ink is discharged from the nozzle 6, the pressure relief valve 101 is normally closed.

It should be noted that the pressure relief valve 101 may be a flow rate adjustment valve which has a function of adjusting the flow rate.

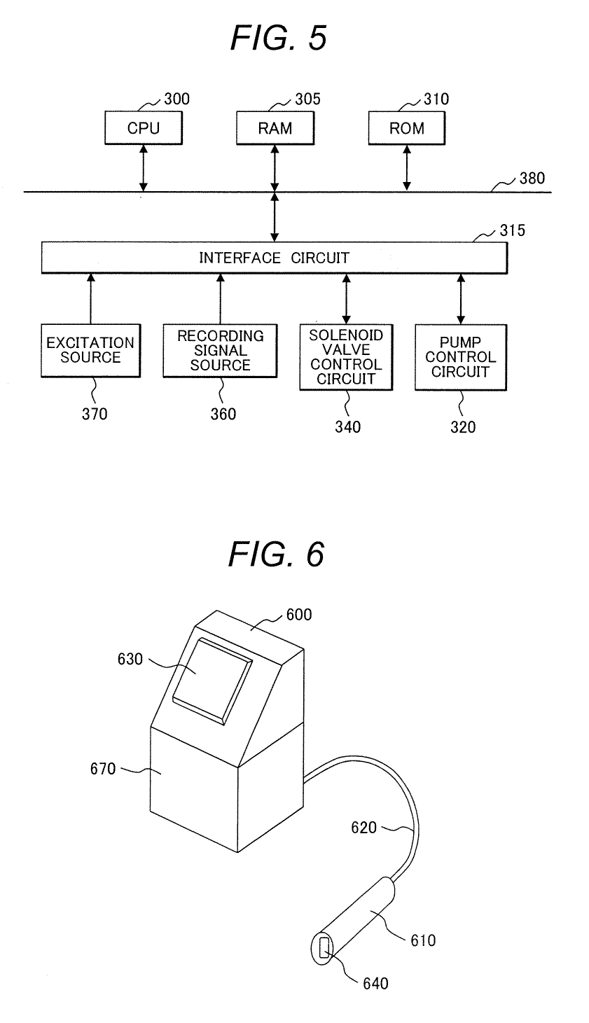

Subsequently, the control circuit 645 of the inkjet recording device will be described with reference to FIG. 5.

The CPU 300 is a central processing unit which controls the inkjet recording device of this Example. The ROM 310 is a read-only memory which stores programs and control data required to operate the CPU 300. The RAM 305 is a rewritable memory which temporarily stores data and the like handled by the CPU 300 in the process of executing a program. A bus line 380 is a signal line which includes all of the data, address signals and control signals from the CPU 300. An interface circuit 315 moderates the data, address signals, control signals and other inputs and outputs.

A pump control circuit 320 controls the operation of the supply pump 2 and recovery pump 14 based on an instruction from the CPU 300. An electromagnetic valve control circuit 340 controls the operations of electromagnetic valves such as the supply valve 33, recovery valve 34 and pressure relief valve 101 based on an instruction from the CPU 300. An excitation source 370 generates an excitation signal based on nozzle operation conditions, and drives a piezoelectric actuator (not shown) at the nozzle 6. A recording signal source 360 generates recording signal and printing presence/absence information for the respective ink particles based on input printing data, stores the information in the RAM 305, and then applies the recording signal to an charged electrode 7 based on an instruction from the CPU 300.

Herein, the flow of the solvent gas will be described with reference to FIG. 2.

FIG. 2 is a timing chart which shows the states of the pumps, valves and other components of the inkjet recording device of Example 1 according to the present invention while recovery is stopped. In this chart, the horizontal axis represents the time of switching operation and the like, while the vertical axis represents the states of the recovery pump 14, recovery valve 34, pressure relief valve 101 and the pressures 25 and 26.

In an ink eject mode during printing operation, the recovery pump 14 is in operation; the recovery valve 34 is open; and the pressure relief valve 101 is closed. At this time, the solvent gas flows from the ink tank 1 to the exhaust circulation line 23 only, and is recovered from the gutter 11 into the ink tank 1 through the ink recovery line 22. In this Example, the pressure 25 (P1) in the ink tank 1 and the pressure 26 (P2) in the exhaust circulation line are in a state of being higher than the atmospheric pressure by about several ten kPa. In addition, the supply pump 2 is in operation, and the supply valve 33 is open in the ink eject mode.

Subsequently, the operation of a recovery stop mode where the ejection of the ink is stopped will be described.

In T0 where the process proceeds from the ink eject mode to the stop mode, the ejection of the ink from the nozzle 6 is stopped by stopping the supply pump 2 and closing the supply valve 33.

In the case of this Example, a fluid resistance of the pressure relief line 24 is sufficiently smaller than that of the exhaust circulation line 23 having the restrictor 44b of the gutter 11. Accordingly, the solvent gas in the ink tank 1 flows from the pressure relief line 24 into the atmosphere by opening the pressure relief valve 101, and the pressure 25 (P1) of the ink tank 1 and the pressure 26 (P2) of the exhaust circulation channel 23 instantly (several ms (milliseconds) or shorter) become equal to the atmosphere. Therefore, the lengths of T0 and T1 may be such response times (several ms or shorter) that the pressures 25 and 26 reach the atmospheric pressure or higher. For this reason, the lengths are 1 second in this Example, which has been confirmed to cause no ink leakage.

Subsequently, the recovery valve 34 is closed at T1 which is after the pressures in the ink tank 1 and exhaust circulation line 23 are lowered to the atmospheric pressure, and further the recovery pump 14 is stopped at T2 to stop the recovery operation. At this time, since the pressure relief valve 101 is open, the pressures 25 (P1) and 26 (P2) are equal to the atmospheric pressure, and the solvent gas in the exhaust circulation line 23 and pressure relief line 24 is static. Therefore, the ink remaining in the first line 41 does not leak out from the gutter 11 by the solvent gas.

Finally, the pressure relief valve 101 is closed at T3, and the recovery stop mode is ended at T4 in a state that the exhaust circulation line 23, ink tank 1 and ink recovery line 22 are left at the atmospheric pressure, whereby the inkjet recording device is stopped.

In this Example, it is confirmed that no problem is caused by setting the time from T1 to T2, the time from T2 to T3, and the time from T3 to T4 to 1 second being equal to or longer than the response times of the recovery pump 14, recovery valve 34 and pressure relief valve 101.

### Example 2

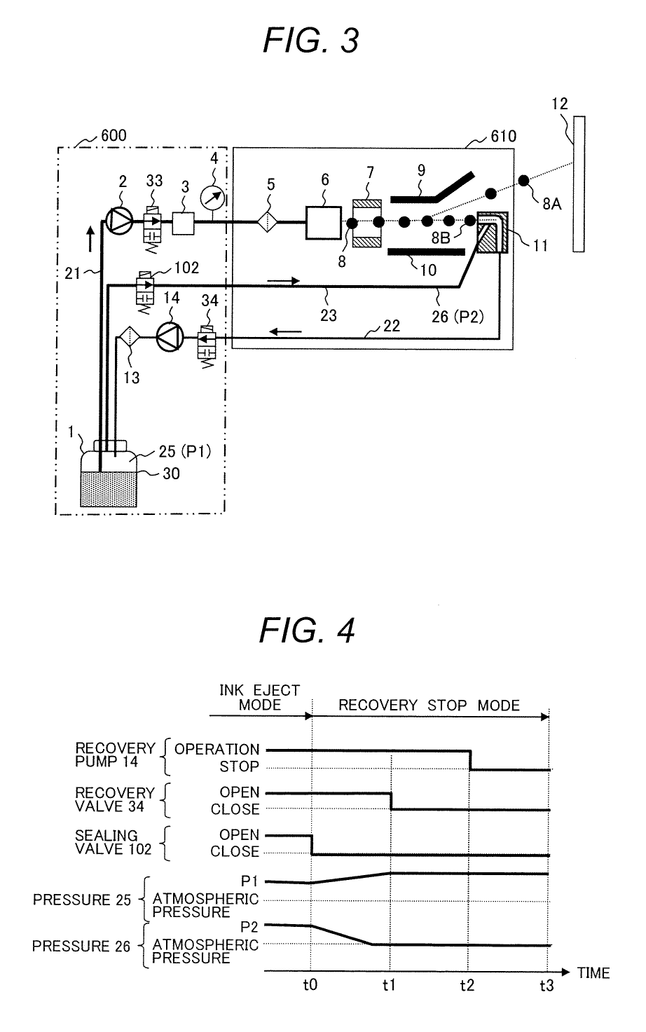

FIG. 3 is a configuration of a second device to obtain the effects of the invention of the inkjet recording device of the present invention without using a pressure relief line 24 in Example 1.

A configuration which is different from that of Example 1 will be described below.

A sealing valve 102 which is capable of opening and closing the exhaust circulation line is provided on the exhaust circulation line 22 which connects the ink tank 1 and the gutter 11. The sealing valve 102 is an electromagnetic two-way valve, which can bring the ink tank 1 and gutter 11 into communication and feed the solvent gas from the ink tank 1 to the gutter 11 in an open state, but cannot feed the solvent gas from the ink tank 1 to the gutter 11 in a closed state.

It should be noted that sealing valve 102 may be a flow rate adjustment valve which has a function of adjusting the flow rate.

Herein, the flow of the solvent gas in an operation mode will be described with reference to FIG. 4.

In the ink eject mode during the printing operation, the recovery pump 14 is in operation; the recovery valve 34 is open; and sealing valve 102 is open. At this time, the solvent gas flows from the ink tank 1 to the exhaust circulation line 23 only, and is recovered from the gutter 11 into the ink tank 1 through the ink recovery line 22. As in Example 1, the pressure 25 (P1) in the ink tank 1 and the pressure 26 (P2) in the exhaust circulation line are in a state of being higher than the atmospheric pressure by about several ten kPa. In addition, the supply pump 2 is in operation, and the supply valve 33 is open in the ink eject mode.

Subsequently, the operation of a recovery stop mode where the ejection of the ink is stopped will be described.

At t0 where the process proceeds from the ink eject mode to the stop mode, the ejection of the ink is stopped from the nozzle 6 by stopping the supply pump 2 and closing the supply valve 33. Moreover, the flow of the solvent gas from the ink tank 1 to the gutter 11 is shut off in order to cause the sealing valve 102 to be in a closed state. Accordingly, the pressure 26 (P2) between the sealing valve 102 and gutter 11 on the exhaust circulation line 23 lowers to the atmospheric pressure gradually (about several seconds or shorter) due to the fluid resistance by the restrictor 44b while feeding the solvent gas to the gutter. However, since the recovery valve 34 is open and the recovery pump 14 is in operation, recovery of the ink from the gutter 11 is continued, and the ink does not leak out from the gutter 11.

Therefore, the time from t0 to t1 may be equal to the response time (about 3 seconds) required for the pressure 26 to reach the atmospheric pressure at the shortest. For this reason, the time is set to 5 seconds in this Example, which has been confirmed to cause no ink leakage.

The pressure 25 (P1) in the ink tank 1 is increased until t1 in which the recovery valve 34 is closed, but the pressure becomes constant thereafter. Moreover, the pressure 26 (P2) is equal to the atmospheric pressure after t1. Therefore, the flow from the exhaust circulation line 23 to the gutter 11 is static, and the ink remaining in the gutter 11 does not leak out from the gutter 11 by the solvent gas at t2 after the recovery pump 14 is stopped.

Finally, the recovery pump 14 is stopped at t2, and the recovery stop mode is ended at t3 in a state that the pressure 26 (P2) is left at the atmospheric pressure, whereby the device is stopped.

The sealing valve 102 at t3 may be temporarily operated to open and close to lower the pressure 25 (P1) of the ink tank 1 to the atmospheric pressure to stop the device.

In this Example, the time form t1 to t2 and the time from t2 to t3 are set to 1 second which is equal to or longer than the response times of the recovery pump 14, recovery valve 34 and sealing valve 102, which is confirmed to cause no problem.

Moreover, the supply valve 33, recovery valve 34 and sealing valve 102 are closed in a state that the recovery stop mode is ended and the device is stopped. Therefore, the leakage of the solvent gas by the evaporation of the ink solvent in the line between the recovery valve 34 and the sealing valve 102 can be reduced. Therefore, the amount of the solvent consumed can be reduced, and the working environment can be also improved due to a lowered concentration of the solvent gas around the device. In addition, a reduced amount of the solvent gas released into the atmosphere contributes to prevention of contamination of the atmosphere and global warming.

That is, according to the present invention, the ink remaining in the gutter and other portions can be prevented from leaking out, and the leakage of the solvent gas by the evaporation of the solvent can be reduced.

According to the present invention, the feeding of the solvent gas to the gutter while the recovery pump is in operation can be stopped. Therefore, the ink remaining in the gutter without being recovered is not caused to flow out from the gutter by the solvent gas, and the fouling of the surrounding of the gutter with the ink after the recovery pump is stopped can be prevented.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

### EXPLANATION OF REFERENCES

1: Ink tank, 2: Supply pump, 5: Filter, 6: Nozzle, 7: Charged electrode, 8: Ink particles, 11: Gutter, 14: Recovery pump, 21: Ink supply line, 22: Ink recovery line, 23: Exhaust circulation line, 24: Pressure relief line, 34: Recovery valve, 101: Pressure relief valve, 102: Sealing valve.

1. An inkjet recording device comprising:
an ink tank for retaining an ink;
a nozzle for discharging the ink as ink particles to print on a printing object;
an ink supply unit for feeding the ink from the ink tank to the nozzle;
a gutter for recovering the ink particles which are not used in printing in the ink tank among the ink particles discharged from the nozzle;
an ink recovery line for returning the ink particles recovered in the gutter to the ink tank; and
an ink recovery unit disposed on the ink recovery line for recovering the ink in the ink tank,
the inkjet recording device having a gas-liquid separation unit for separating a gas returned along with the ink particles through the ink recovery line, a gas supply line for feeding the gas to the gutter and a recovery valve provided on the ink recovery line, and a recovery of the ink by the ink recovery unit being stopped after the recovery valve is closed when the recovery of the ink is stopped.

2. The inkjet recording device according to claim 1,
wherein the gas-liquid separation unit is provided in the ink tank.

3. (canceled)

4. The inkjet recording device according to claim 1,
wherein a valve is provided on the atmosphere relief line.

5. The inkjet recording device according to claim 1,
wherein a valve is provided on the gas supply line.

6. The inkjet recording device according to claim 4 or 5,
wherein the valve provided on the atmosphere relief line and/or the gas supply line is a two-way valve.

7. The inkjet recording device according to claim 6,
including a control unit for stopping recovery of the ink by the ink recovery unit after the valve in the atmosphere relief line is opened.

8. The inkjet recording device according to claim 6,
including a control unit for stopping recovery of the ink by the ink recovery unit after the valve of the gas supply line is closed.
